(19) United States
(12) Patent Application Publication
(10) Pub. No.: US 2014/0152609 A1
(43) Pub. Date: Jun. 5, 2014

(54) TOUCH SENSING DEVICE AND TOUCH SENSING METHOD

(71) Applicant: SAMSUNG ELECTRO-MECHANICS CO., LTD., Suwon (KR)

(72) Inventors: Kang Joo KIM, Suwon (KR); Hyun Suk Lee, Suwon (KR)

(73) Assignee: SAMSUNG ELECTRO-MECHANICS CO., LTD., Suwon (KR)

(21) Appl. No.: 13/766,949

(22) Filed: Feb. 14, 2013

(30) Foreign Application Priority Data
Nov. 30, 2012 (KR) 10-2012-0138428

(51) Int. Cl. G06F 3/044

(52) U.S. Cl. CPC G06F 3/044
USPC 345/174

(57) ABSTRACT

There are provided a touch sensing device and a touch sensing method. The touch sensing device includes a plurality of first electrodes extending in a first axis direction, a plurality of second electrodes extending in a second axis direction intersecting the first axis, and a control unit detecting a plurality of changes in capacitance generated between the plurality of first electrodes and the plurality of second electrodes and thus determining a touch, wherein the control unit determines the touch based on at least one of a plurality of first error information signals corresponding to the plurality of respective first electrodes and a plurality of second error information corresponding to the plurality of respective second electrodes.

### CROSS-REFERENCE TO RELATED APPLICATIONS

This application claims the priority of Korean Patent Application No. 10-2012-0138428 filed on Nov. 30, 2012, in the Korean Intellectual Property Office, the disclosure of which is incorporated herein by reference.

### BACKGROUND OF THE INVENTION

1. Field of the Invention

The present invention relates to a touch sensing device in which a plurality of changes in capacitance generated in a panel unit are converted into digital values and electrical noise, errors, and the like, included in digital values are corrected before a microcontroller unit processes a signal, thereby significantly reducing a calculation load on the microcontroller unit and determining a touch more effectively and quickly, and a touch sensing method.

2. Description of the Related Art

A touch sensing device such as a touch screen, a touch pad, or the like, is an input device attached to a display device to provide an intuitive data input method to a user. Recently, a touch sensing device has been applied to various electronic devices such as portable phones, personal digital assistants (PDAs), navigation devices, and the like. In particular, recently, as demand for smart phones has increased, an employment rate of touch screens as touch sensing devices capable of providing various data input methods in a limited form factor is on the rise.

Touch screens employed in portable devices may be classified into a resistive touch screen and a capacitive touch screen according to a method of sensing a touch utilized thereby. Among these, a capacitive touch screen, having advantages in that it has a relatively long lifespan and various data input methods and gestures are easily implementable therewith, has been increasingly applied. In particular, the capacitive touch screen, facilitating implementation of a multi-touch interface relative to the resistive touch screen, is extensively employed in devices such as smart phones, and the like.

The capacitive touch screen includes a plurality of electrodes having a predetermined pattern, and a plurality of nodes in which capacitance is changed by a touch are defined by the plurality of electrodes. The plurality of nodes distributed on a two-dimensional (2D) plane generate a change in self-capacitance or mutual-capacitance according to a touch, and coordinates of a touch may be calculated by applying a weighted average calculation method, or the like, to the change in capacitance generated in the plurality of nodes. In order to accurately calculate coordinates of a touch, a technique of accurately sensing a change in capacitance generated by a touch is required, but electrical noise generated in a wireless communication module, a display device, and the like, may interfere with accurately sensing a change in capacitance.

In the Related Art Document below, Patent Document 1 refers to a touch screen, and discloses a technique of detecting external environmental factors to set a correction value according to the external environmental factors and correcting coordinates of a touch based on the detected factors. Patent Document 2 also relates to a touch screen, which discloses a technique of identifying a cell having defective linearity and correcting coordinates of the corresponding cell to improve linearity. However, both Patent Documents 1 and 2 do not present a technique of setting error information by electrodes included in a panel unit and correcting a touch error based on the set error information.

### RELATED ART DOCUMENT

(Patent Document 1) Korean Patent Laid-Open Publication No. KR 10-2010-0042756
(Patent Document 2) Korean Patent Laid-Open Publication No. KR 10-2012-0026397

### SUMMARY OF THE INVENTION

An aspect of the present invention provides a touch sensing device and a touch sensing method, capable of effectively correcting an error and reducing a calculation load of a microcontroller unit, by generating a plurality of error information signals by electrodes based on changes in capacitance obtained from a plurality of electrodes included in a panel unit, and correcting a touch error based on the generated error information, and in particular, by correcting an error by using data converted into digital values.

According to an aspect of the present invention, there is provided a touch sensing device including: a plurality of first electrodes extending in a first axis direction; a plurality of second electrodes extending in a second axis direction intersecting the first axis; and a control unit detecting a plurality of changes in capacitance generated between the plurality of first electrodes and the plurality of second electrodes and thus determining a touch, wherein the control unit determines the touch based on at least one of a plurality of first error information signals corresponding to the plurality of respective first electrodes and a plurality of second error information signals corresponding to the plurality of respective second electrodes.

The control unit may correct an error included in the plurality of changes in capacitance, based on at least one of the plurality of first error information signals and the plurality of second error information signals.

The control unit may apply a predetermined driving signal to at least one of the plurality of first electrodes, and detect the plurality of changes in capacitance from the plurality of second electrodes intersecting the at least one first electrode to which the driving signal has been applied.

Each of the plurality of first error information signals may correspond to each of the plurality of first electrodes, and each of the plurality of second error information signals may correspond to each of the plurality of second electrodes.

The control unit may calculate a plurality of first average values corresponding to the plurality of first electrodes, respectively, and a plurality of second average values corresponding to the plurality of second electrodes, respectively, based on the plurality of changes in capacitance, and determine reciprocal numbers of values obtained by normalizing the plurality of first average values, as the plurality of first error information signals, and determine reciprocal numbers of values obtained by normalizing the plurality of second average values, as the plurality of second error information signals.

The control unit may determine a touch by applying at least one of the plurality of first error information signals and the plurality of second error information signals to the plurality of changes in capacitance converted into digital values.

The control unit may include a microcontroller unit (MCU) determining the touch based on the plurality of changes in capacitance to which at least one of the plurality of first error information signals and the plurality of second error information signals has been applied.

According to another aspect of the present invention, there is provided a touch sensing method including: detecting a plurality of changes in capacitance generated in a plurality of nodes; generating a plurality of error information signals based on the plurality of changes in capacitance; correcting an error included in the plurality of respective changes in capacitance, based on at least one of the plurality of error information signals; and determining a touch by using the plurality of error-corrected changes in capacitance.

The generating of error information may include: calculating a plurality of average values corresponding to the plurality of nodes, respectively, based on the plurality of changes in capacitance; and determining reciprocal numbers of values obtained by normalizing the plurality of average values, as the plurality of error information signals.

The detecting of the plurality of changes in capacitance may include converting the plurality of changes in capacitance into digital values.

In the generating of the error information, the plurality of error information signals may be generated, based on the plurality of changes in capacitance converted into digital values.

According to another aspect of the present invention, there is provided a touch sensing device including: a sensing circuit unit detecting a plurality of changes in capacitance generated in a plurality of nodes; a signal conversion unit converting the plurality of changes in capacitance into digital values; an error information generation unit generating a plurality of error information signals based on the plurality of changes in capacitance; and an arithmetic operation unit determining a touch by using the plurality of changes in capacitance which have been converted into the digital values and the plurality of error information signals.

The error information generation unit may calculate a plurality of first average values according to a first axis direction and a plurality of second average values according to a second axis direction by using the plurality of changes in capacitance converted into the digital values, and determine reciprocal numbers of values obtained by normalizing the plurality of first average values and reciprocal numbers of values obtained by normalizing the plurality of second average values, as the plurality of error information signals.

The first axis direction and the second axis direction may correspond to a length direction of the plurality of first electrodes and the plurality of second electrodes forming the plurality of nodes.

The arithmetic operation unit may correct the touch data by using the calculated error information.

The touch sensing device may further include a touch determining unit calculating at least one of the number of touches and coordinates of the touches.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating the exterior of an electronic device including a touch sensing device according to an embodiment of the present invention;

FIG. 2 is a view illustrating a touch screen panel unit that may be included in the touch sensing device according to an embodiment of the present invention;

FIG. 3 is a circuit diagram of the touch sensing device according to an embodiment of the present invention;

FIG. 4 is a flowchart illustrating a touch sensing method according to an embodiment of the present invention; and

FIG. 5 is a block diagram of the touch sensing device according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements maybe exaggerated for clarity, and the same reference numerals will be used throughout to designate the same or like elements.

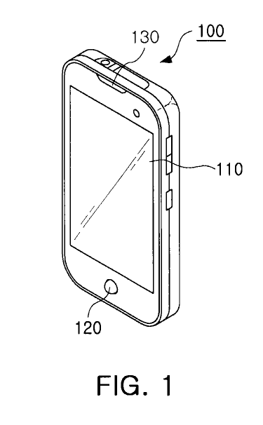

FIG. 1 is a perspective view illustrating the exterior of an electronic device including a touch sensing device according to an embodiment of the present invention.

Referring to FIG. 1, an electronic device 100 according to the present embodiment may include a display unit 110 for outputting a screen, an input unit 120, an audio output unit 130 for outputting a voice, and the like, and a touch sensing device may be integrated with the display unit 110.

As illustrated in FIG. 1, in the case of the mobile device, in general, a touch sensing device is integrated with the display unit, and the touch sensing device is required to have a relatively high degree of light transmittance to allow an image displayed on the display unit to be transmitted therethrough. Thus, the touch sensing device may be implemented by forming a sensing electrode with a material such as indium tin oxide (ITO), indium zinc oxide (IZO), zinc oxide (ZnO), carbon nano-tube (CNT), or graphene having electrical conductivity on a base substrate formed of a transparent film material such as polyethylene terephthalate (PET), polycarbonate (PC), polyethersulfone (PES), polyimide (PI), or the like. A wiring pattern connected to the sensing electrode formed of a transparent conductive material is disposed in a bezel region of the display unit, and since the wiring pattern is visually shielded by the bezel region, the wiring pattern may also be formed of a metal such as silver (Ag), copper (Cu), or the like.

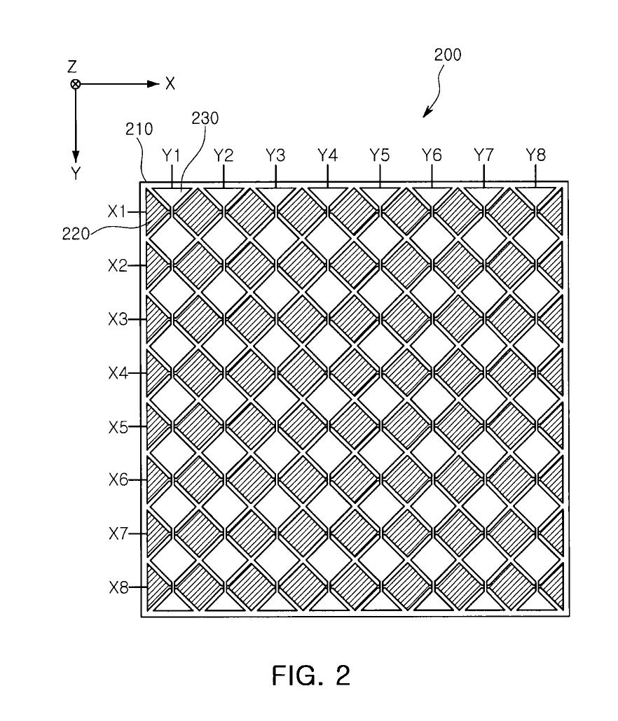

The touch sensing device according to an embodiment of the present invention is assumed to operate according to a capacitive scheme, so it may include a plurality of electrodes having a predetermined pattern. Also, the touch sensing device according to the embodiment of the present invention may include a capacitance detection circuit detecting a change in capacitance generated by a plurality of electrodes, an analog-to-digital conversion circuit converting an output signal from the capacitance detection circuit into digital values, an arithmetic operation circuit determining a touch by using data which has been converted into digital values, and the like. Hereinafter, the touch sensing device and an operation method thereof according to the embodiment of the present invention will be described with reference to FIGS. 2 through 5.

FIG. 2 is a view illustrating a touch screen panel unit that may be included in the touch sensing device according to the embodiment of the present invention.

Referring to FIG. 2, a touch screen 200 according to the present embodiment includes a substrate 210 and a plurality of sensing electrodes 220 and 230 provided on the substrate 210. Although not shown in FIG. 2, the plurality of sensing electrodes 220 and 230 may be electrically connected to a wiring pattern of a circuit board attached to one end of the substrate 210 through a wiring and a bonding pad, respectively. A controller integrated circuit (IC) is mounted on the circuit board to detect a sensing signal generated by the plurality of sensing electrodes 220 and 230 and determine a touch by using the sensing signal.

In the case of the touch screen device, the substrate 210 may be a transparent substrate on which the sensing electrodes 220 and 230 are formed, and may be formed of a plastic material such as polyimide (PI), polymethylmethacrylate (PMMA), polyethyleneterephthalate (PET), or polycarbonate (PC), or tempered glass. Besides a region in which the sensing electrodes 220 and 230 are formed, a predetermined printed region for visually shielding a wiring generally formed of an opaque metal may be formed on the substrate 210 with respect to a region in which the wiring connected to the sensing electrodes 220 and 230 is provided.

The plurality of sensing electrodes 220 and 230 may be formed on one surface of the substrate 210 or on both surfaces thereof. The touch screen device may be formed of ITO, IZO, ZnO, CNT, a graphene material, or the like, which is transparent and has conductivity. In FIG. 2, the sensing electrodes 220 and 230 having a diamond-like pattern are illustrated, but the present invention is not limited thereto and the sensing electrodes 220 and 230 may have various polygonal patterns such as a rectangular pattern, a triangular pattern, or the like.

The plurality of sensing electrodes 220 and 230 include first electrodes 220 extending in an X-axis direction and second electrodes 230 extending in a Y-axis direction. The first electrodes 220 and the second electrodes 230 may be formed on both surfaces of the substrate 210 or may be alternately formed on different substrates 210. In the case in which both the first electrodes 220 and the second electrodes 230 are formed on one surface of the substrate 210, a predetermined insulating layer may be partially formed in intersections of the first electrodes 220 and the second electrodes 230.

The touch sensing device, electrically connected to the plurality of sensing electrodes 220 and 230 to sense a touch, may detect a change in capacitance generated from the plurality of sensing electrodes 220 and 230 according to a touch applied thereto and sense the touch based on the detected change in capacitance. The first electrodes 220 may be connected to channels defined as D1 to D8 in the controller IC to receive a predetermined driving signal, and the second electrodes 230 may be connected to channels defined as S1 to S8 so as to be used for the touch sensing device to detect a sensing signal. Here, the controller IC may detect a change in mutual capacitance generated between the first electrodes 220 and the second electrodes 230, by a sensing signal, and operate to sequentially apply a driving signal to the respective first electrodes 220 and simultaneously detect a change in the capacitance in the second electrodes 230. Namely, when M number of first electrodes 220 and N number of second electrodes 230 are provided, the controller IC may detect M×N number of capacitance change data for determining a touch.

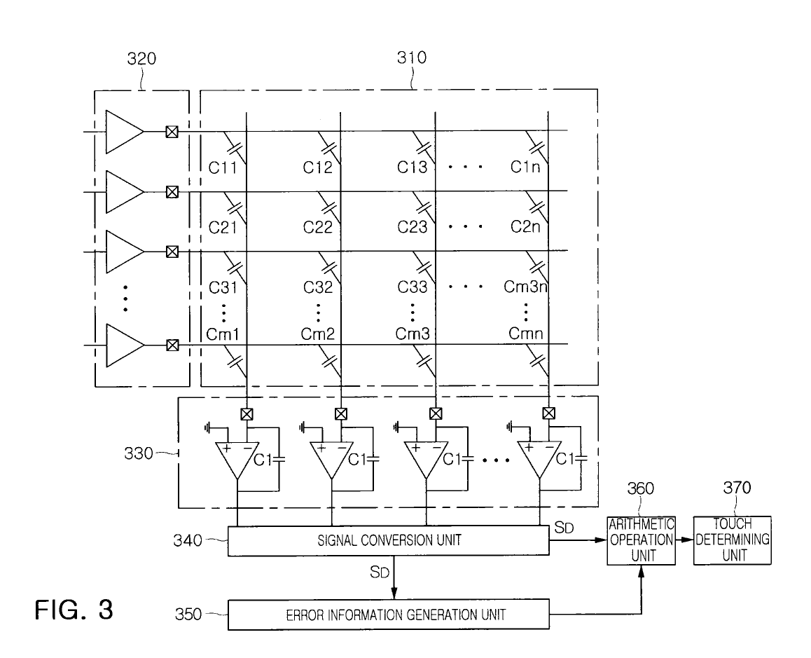

FIG. 3 is a circuit diagram of the touch sensing device according to an embodiment of the present invention.

Referring to FIG. 3, the touch sensing device according to an embodiment of the present invention includes a panel unit 310, a driving circuit unit 320, a sensing circuit unit 330, a signal conversion unit 340, an error information generation unit 350, and an arithmetic operation unit 360. The panel unit 310 includes m number of first electrodes extending in a first axis direction (or a horizontal direction in FIG. 3) and n number of second electrodes extending in a second axis direction (or a vertical direction in FIG. 3) crossing the first axis. Changes in capacitance C11 to Cmn are generated in a plurality of nodes in which the first electrodes and the second electrodes intersect. The changes in capacitance C11 to Cmn generated in the plurality of nodes may be changes in mutual capacitance generated by a driving signal applied to the first electrodes by the driving circuit unit 320. Meanwhile, the driving circuit unit 320, the sensing circuit unit 330, the signal conversion unit 340, the error information generation unit 350, and the arithmetic operation unit 360 may be implemented as a single integrated circuit (IC).

The driving circuit unit 320 applies a predetermined driving signal to the first electrodes of the panel unit 310. The driving signal may have a square wave form, a sine wave form, a triangle wave form, or the like, having a predetermined period and amplitude, and may be sequentially applied to the plurality of respective first electrodes. In FIG. 3, it is illustrated that circuits for generating and applying driving signals are individually connected to the plurality of respective first electrodes, but the present invention is not limited thereto and it may be configured such that a single driving signal generation circuit is provided and a driving signal may be applied to a plurality of respective first electrodes by using a switching circuit. Also, the driving signals may be simultaneously applied to all of the first electrodes or may only be selectively applied to a portion of the first electrodes to simply detect a presence or an absence of a touch.

The sensing circuit unit 330 may include an integrating circuit for sensing the changes in capacitance C11 to Cmn generated in the plurality of nodes. The integrating circuit may be connected to the plurality of second electrodes. The integrating circuit may include at least one operational amplifier and a capacitor C1 having a predetermined capacity. An inverting input terminal of the operational amplifier is connected to the second electrode to convert changes in capacitance C11 to Cmn into an analog signal such as a voltage signal, or the like, and output the same. When driving signals are sequentially applied to the plurality of respective first electrodes, changes in capacitance may be simultaneously detected from the plurality of second electrodes, so n number of integrating circuits corresponding to n number of the second electrodes may be provided.

The signal conversion unit 340 generates a digital signal S_{D} from the analog signal generated by the integrating circuit. For example, the signal conversion unit 340 may include a time-to-digital converter (TDC) circuit measuring a time during which an analog signal in a voltage form output by the sensing circuit unit 330 reaches a predetermined reference voltage level and converting the same into a digital signal S_{D}, or may include an analog-to-digital converter (ADC) circuit measuring an amount by which a level of an analog signal output by the sensing circuit unit 330 changes for a predetermined time and converting the same into a digital signal S_{D}. The arithmetic operation unit 360 processes the digital signal such that it corrects an error of the digital signal S_{D}, or the like, and the touch determining unit 370 determines a touch applied to the panel unit 310 by using output data from the arithmetic operation unit 360. In an embodiment, the touch determining unit 370 may determine a number of touches applied to the panel unit 310, coordinates of the touches, gestures, or the like.

The digital signal S_{D} received by the arithmetic operation unit 360 may be data obtained by digitizing the changes in capacitance C11 to Cmn, and in particular, it may be data indicating a difference in capacitance between a case in which a touch has not been generated and a case in which a touch has been generated. In terms of mobile electronic devices in which a plurality of electronic components are integrated within a limited form factor, the digital signal S_{D} received by the arithmetic operation unit 360 may include electrical noise. Here, in order to correct an error due to electrical noise included in the digital signal S_{D}, the touch sensing device according to the present embodiment may include the error information generation unit 350.

The error information generation unit 350 generates error information for correcting an error that may be generated in determining a touch by using the digital signal S_{D} generated by the signal conversion unit 340. For example, when the driving circuit unit 320 sequentially applies a driving signal to the m number of first electrodes, the sensing circuit unit 330 may detect changes in capacitance from the second electrodes intersecting the first electrodes to which the driving signal has been applied, and generate m×n number of digital data signals, and the error information generation unit 350 may generate (m+n) number of error information signals with respect to each of the m number of first electrodes and the n number of second electrodes by using the m×n number of digital data signals.

The error information generation unit 350 may include a memory for storing the (m+n) number of error information signals, and the (m+n) number of error information signals stored in the memory may be transmitted to the arithmetic operation unit 360 and used therein to correct an error included in the digital signal S_{D}. For example, it is assumed that a driving signal is applied to the second first electrode and the digital signal S_{D} is generated from n number of changes in capacitance detected from the n number of second electrodes. Here, the error information generation unit 350 may retrieve n number of error information corresponding to the index of m=2 from the memory and transmit the same to the arithmetic operation unit 360. When error information signals corresponding to the index of m=2 is not present in the data stored in the memory, or when error information is required to be updated, the error information generation unit 350 generates n number of error information signals by using the digital signal S_{D} and stores the same in a memory region corresponding to the index of m=2.

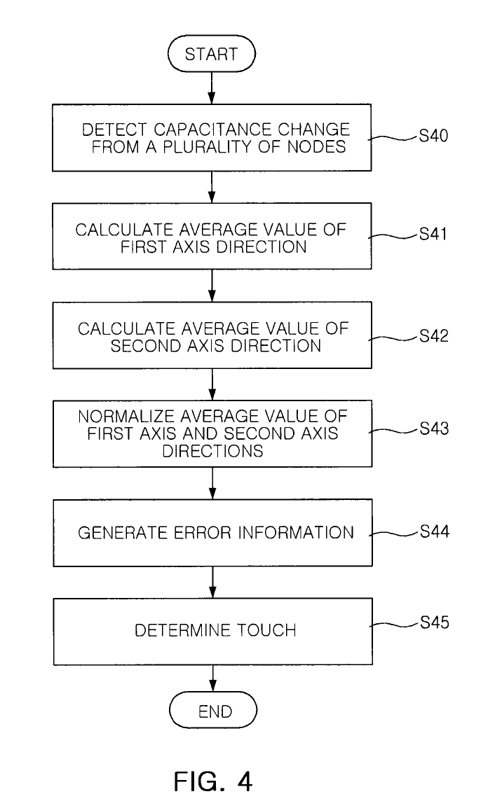

FIG. 4 is a flow chart illustrating a touch sensing method according to an embodiment of the present invention.

Referring to FIG. 4, a touch sensing method according to the embodiment of the present invention starts by detecting a change in capacitance from a plurality of nodes (S40). Referring to FIG. 3, operation S40 may be defined as detecting a change in capacitance by the sensing circuit unit 330 from the (m×n) number of nodes. Here, as described above, the driving circuit unit 320 may sequentially apply a driving signal to the m number of first electrodes, and n number of integration circuits included in the sensing circuit unit 330 may detect changes in capacitance from the n number of second electrodes.

In operation S40, when a change in capacitance with respect to the (m×n) number of nodes is detected, the signal conversion unit 340 converts the detected change in capacitance into a digital signal S_{D}. The converted digital signal S_{D} is transmitted to the error information generation unit 350 and used to generate (m+n) number of error information signals. Hereinafter, a detailed operation of the error information generation unit 350 will be described with reference to Table 1 shown below. For the description purpose, it is assumed that both m and n are 6 and changes in capacitance are detected from 36 nodes.

TABLE 1

| | | | | | | | Average |
|---|---|---|---|---|---|---|---|
| | n = 1 | n = 2 | n = 3 | n = 4 | n = 5 | n = 6 | value |
| m = 1 | 1 | 3 | 3 | 1 | 1 | 2 | 1.83 |
| m = 2 | 2 | 6 | 10 | 8 | 2 | 1 | 4.83 |
| m = 3 | 2 | 7 | 12 | 7 | 1 | 1 | 5 |
| m = 4 | 1 | 2 | 4 | 2 | 1 | 1 | 1.83 |
| m = 5 | 1 | 1 | 2 | 1 | 1 | 1 | 1.17 |
| m = 6 | 1 | 2 | 2 | 1 | 2 | 1 | 1.5 |
| Average | 1.17 | 3.5 | 5.5 | 3.33 | 1.33 | 1.17 | |
| value | | | | | | | |

It is assumed that data is obtained from a total of 36 nodes as shown in Table 1. When a digital signal S_{D} including 36 data is received, the error information generation unit 350 calculates average values of six data with respect to the respective six first electrodes and average values of six data with respect to the respective six second electrodes (S41 and S42).

Namely, there are six data signals 1, 3, 3, 1, 1, and 2 with respect to the first electrode. An average value of the six data signals is approximately 1.83, and in this manner, the error information generation unit 350 calculates average values of the six first electrodes and six second electrodes. The error information generation unit 350 normalizes the obtained (m+n) number of average values, i.e., a total of 12 average values in the present embodiment, and takes a reciprocal number thereof to determine error information regarding the m number of first electrodes and the n number of second electrodes, respectively (S43 and S44).

The error information generated by the error information generation unit 350 is retrieved by the arithmetic operation unit 360 and used to correct an error included in the digital signal S_{D}. The arithmetic operation unit 360 may retrieve error information corresponding to respective indices of the first electrodes and the second electrodes from the error information generation unit 350, and correct error information included in the digital signal S_{D} based on the retrieved error information. Thus, the touch determining unit 370 at a rear stage of the arithmetic operation unit 360 may only perform an operation of determining a touch by using the data (S45), whereby a calculation load of the touch determining unit 370 may be significantly reduced. Accordingly, accuracy and efficiency in determining a touch may be enhanced.

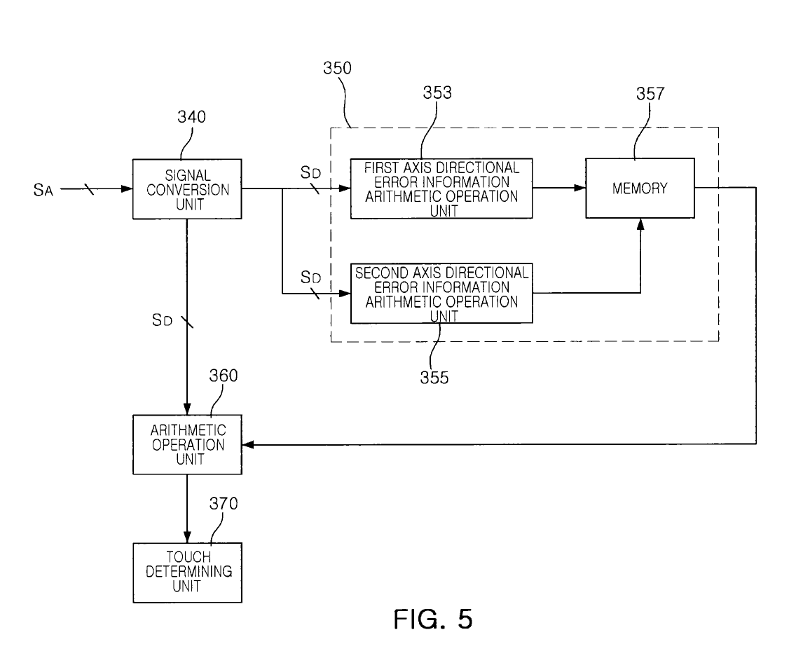

FIG. 5 is a block diagram of the touch sensing device according to an embodiment of the present invention.

Referring to FIG. 5, a configuration of the error information generation unit 350 of the touch sensing unit is illustrated in detail. The signal conversion unit 340 converts capacitance change data S_{A} in an analog form generated by the sensing circuit unit 330 into a digital signal S_{D}. The digital signal S_{D} generated by the signal conversion unit 340 is transferred to the error information generation unit 350 and the arithmetic operation unit 360, respectively.

The error information generation unit 350 may include a first axis directional error information arithmetic operation unit 353, a second axis directional error information arithmetic operation unit 355, and a memory 357 storing data. For example, the first axis directional error information arithmetic operation unit 353 may generate error information regarding each of m number of first electrodes (i.e., driving electrodes receiving a driving signal) extending in a horizontal direction, and the second axis directional error information arithmetic operation unit 355 may generate error information regarding each of n number of second electrodes (i.e., sensing electrodes connected to the sensing circuit unit) extending in a vertical direction, The error (m+n) number of error information signals generated by the first axis directional error information arithmetic operation unit 353 and the second axis directional error information arithmetic operation unit 355 maybe stored in the memory 357 and retrieved by the arithmetic operation unit 360.

The arithmetic operation unit 360 corrects an error that maybe included in each of the (m×n) number of capacitance change data signals generated by the panel unit 310 by using the data signal S_{D} output from the signal conversion unit 340 and the (m+n) number of error information signals stored in the memory 357. As described above, the error information stored in the memory 357 may be a reciprocal number of the value obtained by normalizing the average value of the capacitance change data corresponding to each electrode.

As illustrated in FIGS. 2 and 3, each of the (m×n) number of nodes is formed as the m number of first electrodes and the n number of second electrodes intersected with one another. Thus, the capacitance change data detected from one node may include two error information corresponding to the first electrode and the second electrode forming the corresponding node. The arithmetic operation unit 360 may effectively correct an error included in the capacitance change data by using all of the error information regarding the first electrode and the second electrode forming a corresponding node with respect to each of the (m×n) number of capacitance change data signals. As described above, sensing data whose error has been corrected by the arithmetic operation unit 360 may be transmitted to the touch determining unit 370, and the touch determining unit 370 may determine information including coordinates and a number of touches, a gesture according to the touches, and the like.

As set forth above, according to the embodiments of the invention, changes in capacitance detected by a plurality of nodes are converted into digital value, and error information based on changes in capacitance by electrodes forming the plurality of nodes is generated. Thus, since the digital logic before the microcontroller unit corrects an error included in a touch, a calculation load of the microcontroller unit may be significantly reduced and a rate for determining a touch and efficiency of a touch may be improved.

While the present invention has been shown and described in connection with the embodiments, it will be apparent to those skilled in the art that modifications and variations may be made without departing from the spirit and scope of the invention as defined by the appended claims.

What is claimed is:

1. A touch sensing device comprising:
a plurality of first electrodes extending in a first axis direction;
a plurality of second electrodes extending in a second axis direction intersecting the first axis; and
a control unit detecting a plurality of changes in capacitance generated between the plurality of first electrodes and the plurality of second electrodes and thus determining a touch,
wherein the control unit determines the touch based on at least one of a plurality of first error information signals corresponding to the plurality of respective first electrodes and a plurality of second error information signals corresponding to the plurality of respective second electrodes.

2. The touch sensing device of claim 1, wherein the control unit corrects an error included in the plurality of changes in capacitance, based on at least one of the plurality of first error information signals and the plurality of second error information signals.

3. The touch sensing device of claim 1, wherein the control unit applies a predetermined driving signal to at least one of the plurality of first electrodes, and detects the plurality of changes in capacitance from the plurality of second electrodes intersecting the at least one first electrode to which the driving signal has been applied.

4. The touch sensing device of claim 3, wherein each of the plurality of first error information signals corresponds to each of the plurality of first electrodes, and each of the plurality of second error information signals corresponds to each of the plurality of second electrodes.

5. The touch sensing device of claim 1, wherein the control unit calculates a plurality of first average values corresponding to the plurality of first electrodes, respectively, and a plurality of second average values corresponding to the plurality of second electrodes, respectively, based on the plurality of changes in capacitance, and
determines reciprocal numbers of values obtained by normalizing the plurality of first average values, as the plurality of first error information signals, and determines reciprocal numbers of values obtained by normalizing the plurality of second average values, as the plurality of second error information signals.

6. The touch sensing device of claim 1, wherein the control unit determines the touch by applying at least one of the plurality of first error information signals and the plurality of second error information signals to the plurality of changes in capacitance converted into digital values.

7. The touch sensing device of claim 6, wherein the control unit includes a microcontroller unit (MCU) determining the touch based on the plurality of capacitance changes to which at least one of the plurality of first error information signals and the plurality of second error information signals has been applied.

8. A touch sensing method comprising:
detecting a plurality of changes in capacitance generated in a plurality of nodes;
generating a plurality of error information signals based on the plurality of changes in capacitance;
correcting an error included in the plurality of respective changes in capacitance, based on at least one of the plurality of error information signals; and
determining a touch by using the plurality of error-corrected changes in capacitance.

9. The method of claim 8, wherein the generating of error information includes:
calculating a plurality of average values corresponding to the plurality of nodes, respectively, based on the plurality of changes in capacitance; and
determining reciprocal numbers of values obtained by normalizing the plurality of average values, as the plurality of error information signals.

10. The method of claim 8, wherein the detecting of the plurality of changes in capacitance includes converting the plurality of changes in capacitance into digital values.

11. The method of claim 10, wherein in the generating of the error information, the plurality of error information signals are generated, based on the plurality of changes in capacitance converted into digital values.

12. A touch sensing device comprising:
a sensing circuit unit detecting a plurality of changes in capacitance generated in a plurality of nodes;
a signal conversion unit converting the plurality of changes in capacitance into digital values;
an error information generation unit generating a plurality of error information signals based on the plurality of changes in capacitance; and
an arithmetic operation unit determining a touch by using the plurality of changes in capacitance which have been converted into the digital values and the plurality of error information signals.

13. The touch sensing device of claim 12, wherein the error information generation unit calculates a plurality of first average values according to a first axis direction and a plurality of second average values according to a second axis direction by using the plurality of changes in capacitance converted into the digital values, and
determines reciprocal numbers of values obtained by normalizing the plurality of first average values and reciprocal numbers of values obtained by normalizing the plurality of second average values, as the plurality of error information signals.

14. The touch sensing device of claim 13, wherein the first axis direction and the second axis direction correspond to a length direction of the plurality of first electrodes and the plurality of second electrodes forming the plurality of nodes.

15. The touch sensing device of claim 12, wherein the arithmetic operation unit corrects the touch data by using the calculated error information.

16. The touch sensing device of claim 12, further comprising a touch determining unit calculating at least one of the number of touches and coordinates of the touches.
